(19) United States
(12) Patent Application Publication
(10) Pub. No.: US 2025/0227040 A1
(43) Pub. Date: Jul. 10, 2025

(54) ENHANCED TELECOMMUNICATIONS NETWORK-INFORMED ACTIVATION ESTIMATION

(71) Applicant: Level 3 Communications, LLC, Denver, CO (US)

(72) Inventors: Allen SUTTON, Casselberry, FL (US); David HASHMAN, Arvada, CO (US); Jason PARRIS, Gardner, KS (US)

(73) Assignee: Level 3 Communications, LLC, Denver, CO (US)

(21) Appl. No.: 19/012,786

(22) Filed: Jan. 7, 2025

Related U.S. Application Data
(60) Provisional application No. 63/618,841, filed on Jan. 8, 2024.

(51) Int. Cl. H04L 41/5051; H04L 41/50

(52) U.S. Cl. CPC H04L 41/5051; H04L 41/5058

(57) ABSTRACT

This disclosure describes systems, methods, and devices related to estimating a provisioning of resources in a telecommunications network. A method may include receiving, at a first time, a user request for a service facilitated by a telecommunications network; identifying, based on the service, a device or port to which the user connects to access the telecommunications network; retrieving, using discovery commands, information from one or more additional devices in the telecommunications network; identifying, based on the information, a second device to which the device or port may connect to generate a path to an endpoint of the telecommunications network; identifying, based on the device or port and the second device, a path from the location of the user to the endpoint in the telecommunications network; generating an estimated time to provision the service using the path; and presenting, at the first time, the estimated time to provision the service.

### CROSS-REFERENCE TO RELATED APPLICATIONS

This application claims the benefit of priority from U.S. Provisional Patent Application No. 63,618,841, filed Jan. 8, 2024, which is incorporated herein by reference in its entirety.

### TECHNICAL FIELD

Embodiments of the present disclosure relate to systems and methods for estimating activating of services and devices in a telecommunications network.

### BACKGROUND

In some telecommunications network systems, when a customer requests services provided by the telecommunications network, the customer may purchase the services, triggering a time period during which the telecommunications network service is to estimate the amount of time needed to activate the services. This process is inefficient because at the time of purchase, the customer is unaware of the activation time required. Current estimations are not informed by actual telecommunications network data to provide a real-time activation estimate to a customer at the time of the customer's service request.

### SUMMARY

According to some embodiments, a method for estimating a provisioning of resources in a telecommunications network is disclosed, which according to some embodiments, can include: receiving, at a first time, a user request for a service facilitated by a telecommunications network, the user request identifying a location of a user; identifying, based on the service, a device or port to which the user connects to access the telecommunications network; sending, based on the device or port, discovery commands to retrieve information from one or more additional devices in the telecommunications network; retrieving, based on the discovery commands, the information from the one or more additional devices; identifying, based on the information, a second device to which the device or port may connect to generate a path to an endpoint of the telecommunications network; identifying, based on the device or port and the second device, a path from the location of the user to the endpoint in the telecommunications network; generating an estimated time to provision the service using the path; and presenting, at the first time, the estimated time to provision the service using the path.

According to some embodiments, a system for estimating a provisioning of resources in a telecommunications network is disclosed, which according to some embodiments, can include: a memory coupled to at least one processor, the at least one processor configured to: receive, at a first time, a user request for a service facilitated by a telecommunications network, the user request identifying a location of a user; identify, based on the service, a device or port to which the user connects to access the telecommunications network; send, based on the device or port, discovery commands to retrieve information from one or more additional devices in the telecommunications network; retrieve, based on the discovery commands, the information from the one or more additional devices; identify, based on the information, a second device to which the device or port may connect to generate a path to an endpoint of the telecommunications network; identify, based on the device or port and the second device, a path from the location of the user to the endpoint in the telecommunications network; generate an estimated time to provision the service using the path; and present, at the first time, the estimated time to provision the service using the path.

According to some embodiments, a non-transitory computer-readable storage medium includes instructions to cause at least one processor for estimating a provisioning of resources in a telecommunications network is disclosed, where, upon execution of the instructions by the at least one processor, cause the processor to: receive, at a first time, a user request for a service facilitated by a telecommunications network, the user request identifying a location of a user; identify, based on the service, a device or port to which the user connects to access the telecommunications network; send, based on the device or port, discovery commands to retrieve information from one or more additional devices in the telecommunications network; retrieve, based on the discovery commands, the information from the one or more additional devices; identify, based on the information, a second device to which the device or port may connect to generate a path to an endpoint of the telecommunications network; identify, based on the device or port and the second device, a path from the location of the user to the endpoint in the telecommunications network; generate an estimated time to provision the service using the path; and present, at the first time, the estimated time to provision the service using the path.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is an example process for estimating a service activation using a telecommunications network path in accordance with some embodiments of the instant disclosure.

FIG. 2 is an example process for estimating a service activation using a telecommunications network path in accordance with some embodiments of the instant disclosure.

FIG. 3 is a flow for a process for estimating a service activation using a telecommunications network path in accordance with some embodiments of the instant disclosure.

FIG. 4 is an example machine learning model for estimating a service activation using a telecommunications network path in accordance with some embodiments of the instant disclosure.

FIG. 5 is a diagram illustrating an example of a computing system that may be used in implementing embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example

Certain embodiments and principles will be discussed in more detail with reference to the figures. According to some embodiments, as discussed herein, the instant disclosure provides systems, methods, and the like, for estimating activation of services and devices in a telecommunications network in real-time when a customer requests telecommunications network service.

When a user of a telecommunications network requests activation of telecommunications network resources for one or more services, existing systems use a “buy now, quote later” model in which the customer agrees to purchase the service from the telecommunications network, and be provided later (e.g., within 90 days) an estimate of how long the activation will require and how much the activation will cost.

In particular, when the customer requests the service, an inventory-based build may occur to develop a path between the user and one or more endpoints, and to activate computer resources along the path to facilitate one or more services. A typical user order for a telecommunications network may include the user providing some information, an inventory-based design (e.g., system architecture) of the network path for the user being generated, and a quote estimating the amount of time needed to build the design for the user being provided to the user. However, it often takes weeks or months to estimate the time needed to build the design to activate the services for the user.

In one or more embodiments, to provide a real-time estimate of the time needed to build the design to activate the services for the user (e.g., at the time when the user makes the service request), actual network data may inform the estimate. For example, by walking the telecommunications network to generate a network path to identify available resources rather than relying exclusively on the network inventory records for network resource status information. A system may retrieve the network resources before the build. Such a “network as inventory” approach may allow the system to identify available network resources such as virtual local area networks, subinterfaces, route targets, and the like to establish network paths between users and a network core by identifying a next connected device and port (e.g., next hop) in a real-time manner. For example, the system may examine the network to identify a port to provision, identify an available virtual local area network on that port, and assign that port to the service for the user (e.g., a new or existing customer of the telecommunications network). As resulting technical advancements compared to previous estimation and provisioning techniques, the generated network path estimations herein may be more reliable and available faster to a user, and the estimate for generating the network path and providing the service may be both faster and more accurate than a manual inventory-based approach relying on the network inventory records.

For example, a telecommunications customer may provide their location, the product (e.g., telecommunications service or otherwise, such as Internet, Ethernet, Multiprotocol Label Switching, Wave Services, or the like) the customer is requesting, optional bandwidth requested by the customer, and at the click of a button (e.g., a request), a system application call may be generated and provided to a system application that may perform path computations in the telecommunications network to estimate the network path from the user's location to one or more endpoints to provide the requested telecommunications network product to the customer. For example, the system application may identify equipment at or nearby the customer's location to connect the customer to the telecommunications network (e.g., to an available device or port in the network). From there, the system application may continue to identify available devices and/or ports (e.g., available for the product and to the customer) to which to connect until reaching the one or more endpoints. When the network path is identified and available (e.g., a “happy path”), the system application may return to the customer, in real-time in response to the customer's request, an estimate of the amount of time and cost to generate the network path and provision the requested product. The customer may be prompted to select a date when a technician may perform installation/configuration of network devices (e.g., on-premises), beginning on the date estimated. When the network path encounters an “unhappy path,” such as when a device is missing in the network to provide the path, a circuit needs to be added to generate the path, bandwidth is insufficient to meet the customer's request, etc., the system application may determine a longer estimate than the happy path estimate.

In one or more embodiments, to build the path while avoiding errors, the system may walk the network to identify available resources rather than relying exclusively on the network inventory for network resource status information. The system may retrieve the network resources before the build. Such a “network as inventory” approach may allow the system to identify available network resources such as virtual local area networks, subinterfaces, route targets, and the like to establish network paths between users and a network core by identifying a next connected device and port (e.g., next hop) rather than relying on network inventory that may not reflect the most updated status information of network resources. For example, rather than using network inventory to identify an available virtual local area network, the system may examine the network to identify a port to provision, identify an available virtual local area network on that port, and assign that port to the service for the user. As a result, the estimate to build a network path and turn up a service may be faster and more accurate than the traditional estimation described above.

In one or more embodiments, rather than relying on network inventory, the network path from a user's location to an endpoint may be based on the service requested by the user, the amount of bandwidth requested by the user, and potentially other information. When the user provides this information to the system, the system may identify devices and ports near the user's location, identify resources to provision for the service, and continue to identify a next device and port(s) for the service (e.g., based on the availability and capabilities of the resources in comparison to the requested service and bandwidth of the user) until the path is constructed. The system may follow up with a user to inform the user of the status (e.g., success or failure) of the provisioning of the network path regardless of the status of the inventory, so the inventory synchronization and updating may not delay the user's ability to use the network.

In one or more embodiments, a telecommunications network user may provide a request for a service facilitated by the telecommunications network. A provisioning system of the network may receive the request, which may identify the user, the user's location (e.g., device/network location), requested service(s), and requested bandwidth (e.g., if the service is a bandwidth service), for example. The information provided in the request may be based on the requested service. Based on the request, the provisioning system may discover a network path by retrieving network resources from the network. For example, the provisioning system may connect to a device or port of the user's location (e.g., a device or port to which the user has connected to access the telecommunications network), send discovery commands (e.g., using multicast label distribution protocol or the like) to retrieve information from other network devices, and identify the nearby devices based on responses to the discovery commands until a path to the desired destination is generated. Similarly, the provisioning system may retrieve any virtual local area networks configured on the network devices and subinterfaces on ports of the network devices to identify next available devices, virtual local area networks, subinterfaces, route targets, and the like for the network path. The provisioning system may estimate the time and cost needed to generate the network path and turn up the resources to provide the requested services, and may provide the estimate to the user in real-time with respect to the user's request.

In addition, rather than the estimate to build the path and provision the service being based on general averages for certain services and their typical network resources, the estimates may be personalized to the requesting user based on the user's location, the requested services, the particular resources involved, whether the path is a happy path or needs a build, whether the build is larger or more complex, and the like. For example, instead of the estimate for a large build being a certain number of days, and using that as the estimate, the estimate may be customized for the user's particular location and the specific network resources involved in the path. Instead of the estimate being based on provisioning times over the last few months, for example, the estimate is based on the current status of the network and the user's particular context. In this manner, not only does the user receive a more timely (e.g., real-time) estimate for the provisioning, but the estimate is more technically accurate because of the ability to communicate with network resources to determine the network path.

The above descriptions are for purposes of illustration and are not meant to be limiting. Numerous other examples, configurations, processes, etc., may exist, some of which are described in greater detail below. Example embodiments will now be described with reference to the accompanying figures.

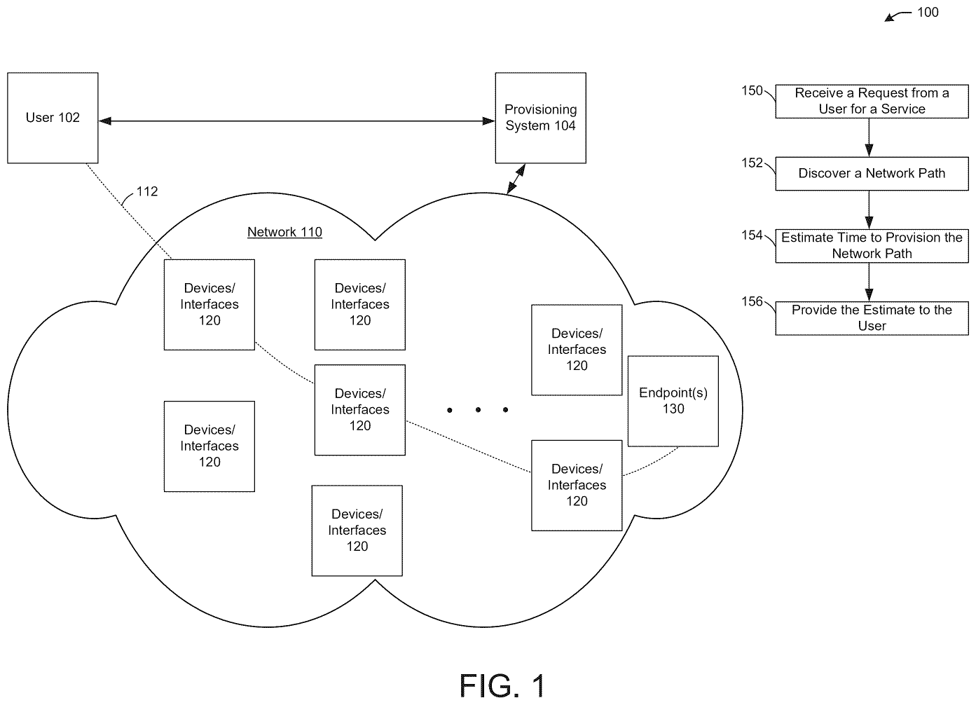

FIG. 1 is an example process 100 for estimating a service activation using a telecommunications network path in accordance with one embodiment.

Referring to FIG. 1, user 102 may request, to a provisioning system 104 of a telecommunications network 110, a service using the telecommunications network 110. The request may identify the service(s) requested by the user 102 and additional information, such as the location of the user 102 (e.g., user's device or a device/port to which the user's device connects to access the network 110). The service may use a network 110 and a path 112 through the network from the API user 102, through one or more devices/interfaces 120 (e.g., resources of the network 110), and to an endpoint 130 for the service (e.g., within a core network).

Still referring to FIG. 1, the provisioning system 104 may receive the request from the user at block 150. In response to the user request for a service, the provisioning system 104 may discover a network path, at block 152, from the user 102 (or device/port to which the user 102 connects to access the network 110) to the one or more endpoints 130 for the requested service. To discover the network path, the provisioning system 104 may send commands to the devices/interfaces 120 in the network 110 requesting information about devices, interfaces/subinterfaces, virtual local area networks, and the like. Using the information received from the network resources in response to the commands, the provisioning system 104 may identify a next available device/port (e.g., nearest to the user's location), and a next nearest available device/port from there, and so on, until the path 112 is generated for the requested service. When the service has certain requirements, such as bandwidth, the next available device/port may be selected based on whether the nearby device/port can support the service and its requirements. The provisioning system 104 also may use inventory data of the telecommunications network 110, including data indicating which devices, ports, interfaces, and the like of the telecommunications network 110 are being used or are available for use by the user to provide the requested service.

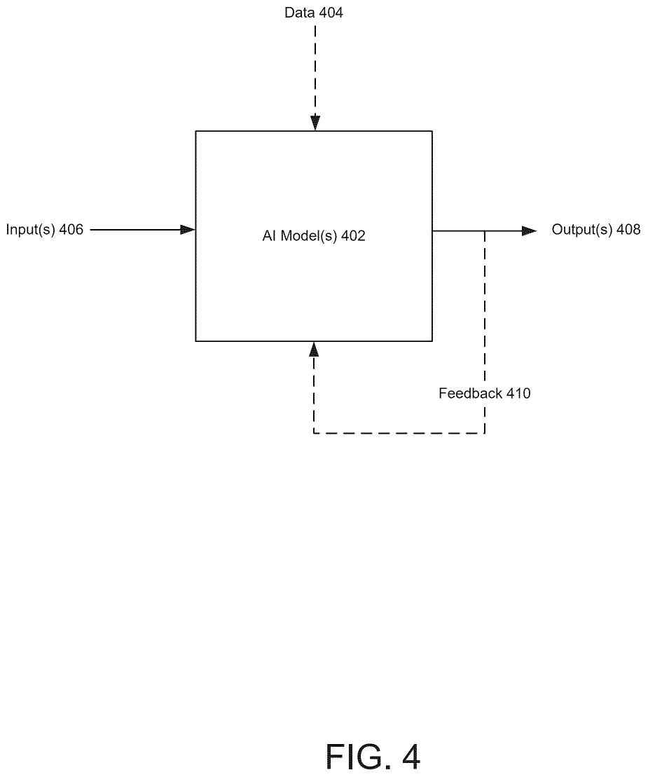

At block 154, when the path 112 is discovered, the provisioning system may estimate the time and cost to provision the path 112 and turn up the resources of the path 112 to provide the requested service. The estimate may be based on the number of resources involved, the types of the resources, the complexities of the configuration (e.g., how much configuration is involved, whether the path is a happy path or not, etc.). The estimate may be based on previous provisioning examples, but customized for the particular locations and resources of the path 112. For example, a previous provisioning to turn up a same or similar service to the service requested by the user using a similar amount and/or type of resources may provide an estimate, but by identifying the specific resources needed to build the path 112, the estimate may be customized. In one or more embodiments, machine learning may be applied to generate the estimate (e.g., described further with respect to FIG. 4).

At block 156, the provisioning system 104 may respond to the user's request with a confirmation of the path 112 for the service and an estimate of the time and cost to activate the path 112 and provide the service. The estimate may be provided in real-time with respect to the request at block 150.

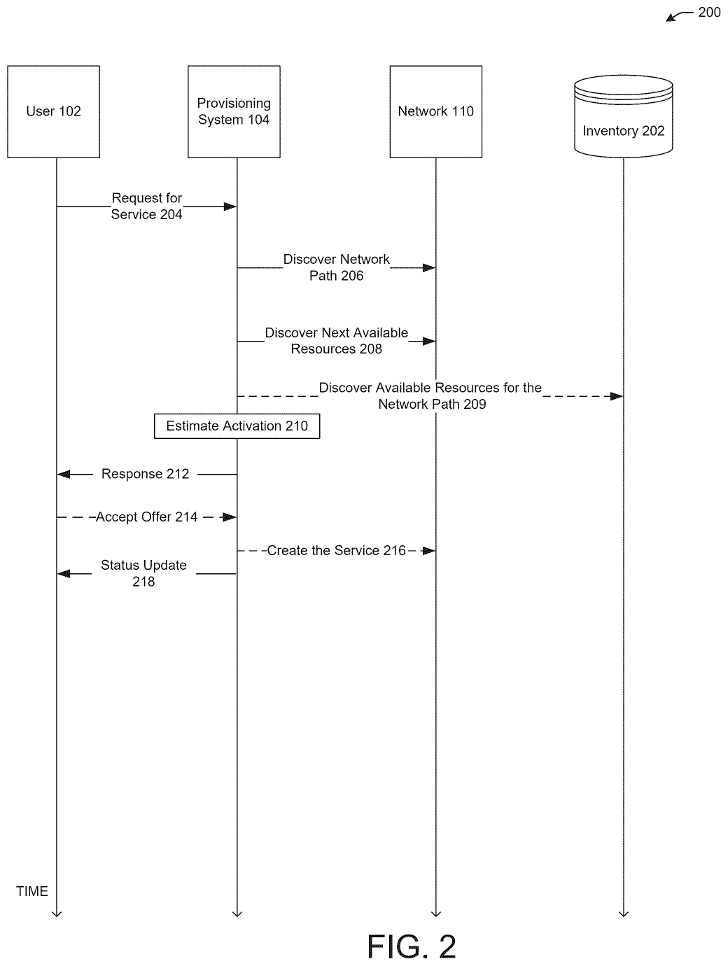

FIG. 2 is an example process 200 for estimating a service activation using a telecommunications network path in accordance with one embodiment.

Referring to FIG. 2, the provisioning system 104 of FIG. 1 may have access to network inventory 202, which may document the use of resources on the network 110. For example, when a network path such as the path 112 is generated, the network inventory 202 may be updated to reflect the use of the devices, ports, subinterfaces, virtual local area networks, and the like used to provide the service using the path 112. The process 200 may include the user 102 requesting 204 a service (e.g., as in block 150). Based on the requested service(s) and other information in the request 204, the provisioning system 104 may discover a network path 206 (e.g., as in block 152, discovering the path 112 of the network 110) and next available network resources 208 with or without having to use the network inventory 202. In this manner, building the network path may at least in part use the network 110 itself as the inventory by requesting information from network resources to identify a next hop in the path 112 to satisfy the user's requested service. Optionally, the provisioning system 104 may rely at least partially on the inventory 202 to identify 209 the network path.

Still referring to FIG. 2, the provisioning system 104 may estimate activation 210 of the service using the network path. The estimate may be based on the number of resources involved, the types of the resources, the complexities of the configuration (e.g., how much configuration is involved, etc.). The estimate may be based on previous provisioning examples. For example, a previous provisioning to turn up a same or similar service to the service requested by the user using a similar amount and/or type of resources may be used to estimate the time and cost. The estimate may be generated in real-time with respect to the user's request 204 for the service, and provided to the user 102 as an offer (e.g., response 212) to the user 102 to accept or reject before provisioning the service using the path and before charging the user 102 for the activation. Optionally, the user 102 may accept the offer 214 to provision the service using the path based on the estimated time and cost for the activation. In response to the acceptance, the provisioning system 104 may create the service 216 (optionally) using the network path. The provisioning system 104 may verify that the estimated time is still accurate. For example, the provisioning system 104 may walk the network again to verify that the estimated path 112 is still available and does not need additional configuration that would require more time than the estimated time (e.g., in which case, the provisioning system 104 may update the user 102 with an updated estimate). The provisioning system 104 may provide a status update 218 to the user 102 to confirm whether the service has been provisioned using the path 112.

In one or more embodiments, to generate the estimated provisioning time and cost, the provisioning system 104 may determine port availability, device compatibility (e.g., device X may not be configured to use a VPN, but device Y might be able to use the VPN), bandwidth capabilities, architecture type (e.g., a larger bandwidth service may require a newer device with higher bandwidth capabilities, etc.), live capacity checks, provider edge (PE) device validations (e.g., correct PE device type for a service, etc. because certain PEs are reserved for certain services and not for others), reservations (e.g., determine whether a port or circuit has been reserved for a particular use/user), inventory status, valid combinations of devices for a path (e.g., a certain order of devices, topology types, whether resources are off the telecommunications networks, etc.), and the like. When a solution uses resources off the telecommunications network (e.g., off-net), the estimate can be based off of how long the other telecommunications network venders take to provision a service. When the network path is a happy path, the estimate can be based off of the actual availability of the network resources. When the network path is constrained (e.g., not a happy path), such as when a network card or box, etc. is missing from the path, the estimate may consider what time is required to resolve missing resources for the path.

In one or more embodiments, to build the path 112 while avoiding errors, the provisioning system 104 may walk the network 110 to identify available resources rather than relying exclusively on the network inventory 202 for network resource status information. The provisioning system 104 may retrieve the network resources before the build and before the user 102 accepts an offer to build the path 112. For example, the provisioning system 104 may examine the network 110 to identify a port to provision, identify an available virtual local area network on that port, and assign that port to the service for the user 102. As a result, generated network connections of the path 112 may be more reliable and available faster to the user 102, allowing for a real-time estimate to the user 102 as a part of the offer for the user 102 to accept before agreeing to the activation (e.g., in contrast with the agreeing to the activation and later being provided the estimated time and cost).

In one or more embodiments, rather than relying solely on the network inventory 202, the network path 112 from a user's location to an endpoint may be based on the service requested by the user 102, the amount of bandwidth requested by the user, and potentially other information. When the user 102 provides this information to the provisioning system 104, the provisioning system 104 may identify devices and ports near the user's location, identify resources to provision for the service, and continue to identify a next device and port(s) for the service (e.g., based on the availability and capabilities of the resources in comparison to the requested service and bandwidth of the user) until the path 112 is constructed.

In one or more embodiments, the user 102 may provide a request for a service facilitated by the telecommunications network 110. Based on the request, the provisioning system 104 may discover the network path 112 by retrieving network resources from the network 110 and/or by using the network inventory 202 data. For example, the provisioning system 104 may connect to a device or port of the user's location (e.g., a device or port to which the user has connected to access the telecommunications network), send discovery commands (e.g., using multicast label distribution protocol or the like) to retrieve information from other network devices, and identify the nearby devices based on responses to the discovery commands until the path 112 is generated. Similarly, the provisioning system 104 may retrieve any virtual local area networks configured on the network devices and subinterfaces on ports of the network devices to identify next available devices, virtual local area networks, subinterfaces, route targets, and the like for the network path 112. The provisioning system 104 may create the service using the network path 112, and respond to the user 102 with the response 212, including the real-time estimate of time and cost to provision the service using the path.

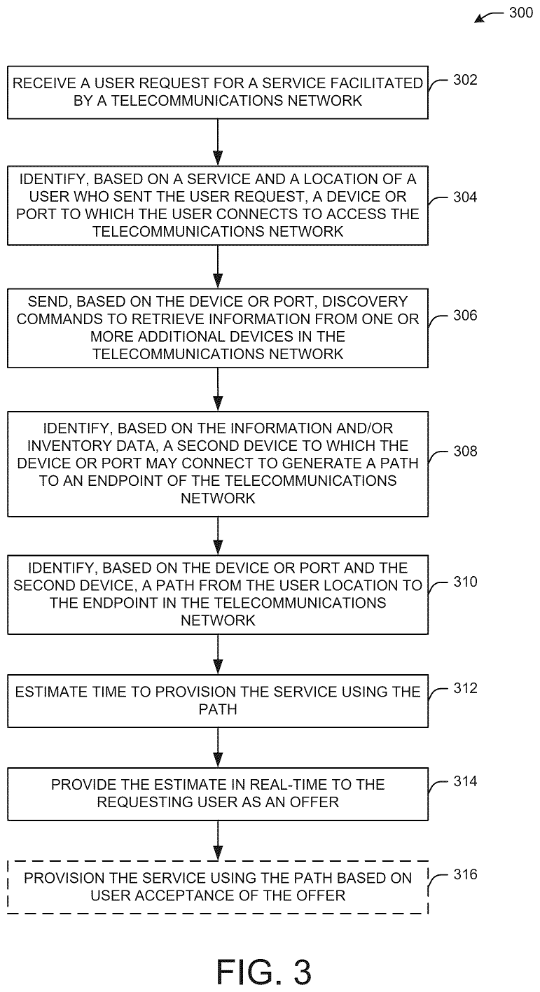

FIG. 3 is a flow for a process 300 for estimating a service activation using a telecommunications network path in accordance with one embodiment.

At block 302, the process 300 (e.g., using the provisioning system 104 of FIG. 1, the provisioning devices 409 of FIG. 4) may receive a user request for a service facilitated by the telecommunications network. The service may not be provisioned yet by the telecommunications network for the user. Instead of building an inventory-based estimate to present to the user regarding an estimated amount of time to provision the requested service, the device may provision the service in real-time and allow the user to use the service without presenting an offer or before presenting an offer for using the service.

At block 304, the process 300 may identify, based on the requested service and a location of the user (e.g., identified by the user request), a device or port to which the user connects to access the telecommunications network.

At block 306, the process 300 may send, based on the device or port, discovery commands to retrieve information from one or more additional devices in the telecommunications network. Because the telecommunications network may support different types/brands of devices, ports, etc., the process 300 may need to identify nearby devices and which protocols they use for communication, and use those protocols for the commands.

At block 308, the process 300 may identify, based on the retrieved information, a second device (and other devices) in the telecommunications network to which the device or port (or a subsequent device or port along a path) to an endpoint of the network to form a path for the service.

At block 310, the process 300 may identify, based on the device or port and based on any subsequent devices or ports (e.g., the second device), a path from the user's location to the endpoint in the telecommunications network to facilitate the service for the user. The path may be happy or constrained.

At block 312, the process 300 may estimate the time to provision the service based on the path. To generate the estimated provisioning time and cost, the provisioning system 104 may determine port availability, device compatibility (e.g., device X may not be configured to use a VPN, but device Y might be able to use the VPN), bandwidth capabilities, architecture type (e.g., a larger bandwidth service may require a newer device with higher bandwidth capabilities, etc.), live capacity checks, provider edge (PE) device validations (e.g., correct PE device type for a service, etc. because certain PEs are reserved for certain services and not for others), reservations (e.g., determine whether a port or circuit has been reserved for a particular use/user), inventory status, valid combinations of devices for a path (e.g., a certain order of devices, topology types, whether resources are off the telecommunications networks, etc.), and the like. When a solution uses resources off the telecommunications network (e.g., off-net), the estimate can be based off of how long the other telecommunications network venders take to provision a service. When the network path is a happy path, the estimate can be based off of the actual availability of the network resources. When the network path is constrained (e.g., not a happy path), such as when a network card or box, etc. is missing from the path, the estimate may consider what time is required to resolve missing resources for the path.

At block 314, the process 300 may include providing the estimate in real-time to the user as an offer to accept or reject. When the user accepts the offer, the process 300 optionally may at block 316 provision the service for the user based on the path without estimating time to provision and presenting the time to provision to the user as an offer for the user to accept in advance. Once the user requests the service and the path is generated in the network, the path and service may be provisioned by configuring and turning up the devices in the path (e.g., using their respective protocols to send commands).

It is understood that the above descriptions are for purposes of illustration and are not meant to be limiting.

FIG. 4 is an example machine learning model 402 for estimating a service activation using a telecommunications network path in accordance with one embodiment.

Referring to FIG. 4, the machine learning model 402 may be used by the provisioning system 104 of FIG. 1 to estimate the time and cost to build the path 112 to provision a service. The machine learning model 402 optionally may receive data 404 for training. The data 404 may include previous requests to provision a service, network resources used to build a network path to provision requested services, the time and cost needed for the building and provisioning, the user responses to the estimates (e.g., accepted or rejected), and the accuracy of the estimates (e.g., was the provisioning performed within the estimated time and cost), for example. The machine learning model 402 may receive inputs 406, such as information from the user request (e.g., requested services/products, user location, bandwidth needs, etc.). The inputs 406 also may include prompts which may include requested outputs 408 for the machine learning model 402 to generate (e.g., estimated times and costs for provisioning, confidence scores in how likely the estimated time will be met, predicted likelihoods that the user will accept an estimate, and the like). The data 404 may represent zero-shot, few-shot, or multi-shot learning depending whether the data include any examples in the inputs 406.

In one or more embodiments, the machine learning model 402 may identify and learn from previous path builds and service provisioning to estimate future ones. For example, the machine learning model 402 may use regression to determine estimates of builds with similar parameters until the estimates regress to values indicative of the predicted times and values. The machine learning model 402 may customize the estimated values using specific information from path walks and/or inventory data for the specific network resources, and to account for the likelihood of a user accepting an estimate.

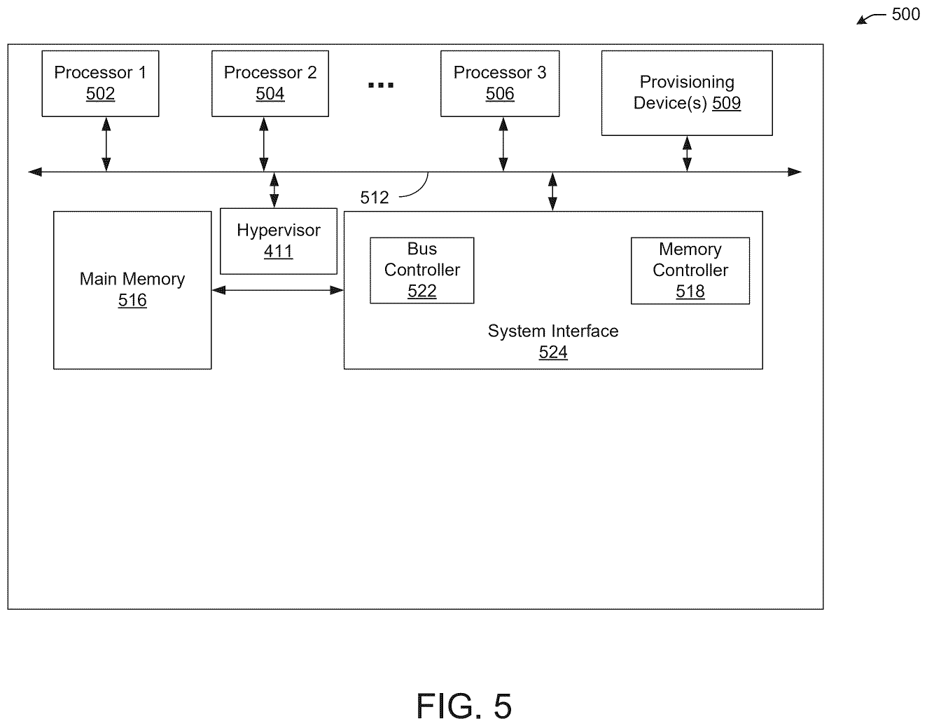

FIG. 5 is a block diagram illustrating an example of a computing device or computer system 500 which may be used in implementing the embodiments of the components of the network disclosed above. For example, the computing system 500 of FIG. 5 may represent at least a portion of FIG. 1, as discussed above, such as components of the user 102, the provisioning system 104, the devices/interfaces 120, and/or the endpoints 130. The computer system (system) includes one or more processors 502-506, one or more provisioning devices 509 (e.g., representing at least a portion of the provisioning system 104 and including one or more software modules), and a hypervisor 511 (e.g., to instantiate and run virtual machines). Processors 502-506 may include one or more internal levels of cache (not shown) and a bus controller 522 or bus interface unit to direct interaction with the processor bus 512. Processor bus 512, also known as the host bus or the front side bus, may be used to couple the processors 502-506 with the system interface 524. System interface 524 may be connected to the processor bus 512 to interface other components of the system 500 with the processor bus 512. For example, system interface 524 may include a memory controller 518 for interfacing a main memory 516 with the processor bus 512. The main memory 516 typically includes one or more memory cards and a control circuit (not shown). System interface 524 may also include an input/output (I/O) interface 520 to interface one or more I/O bridges 525 or I/O devices with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device.

System 500 may include a dynamic storage device, referred to as main memory, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include a read only memory (ROM) and/or other static storage device coupled to the processor bus 512 for storing static information and instructions for the processors 502-506. The system outlined in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 506 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 516, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations together with all equivalents thereof.

What is claimed is:

1. A method comprising:
receiving, at a first time, a user request for a service facilitated by a telecommunications network, the user request identifying a location of a user;
identifying, based on the service, a device or port to which the user connects to access the telecommunications network;
sending, based on the device or port, discovery commands to retrieve information from one or more additional devices in the telecommunications network;
retrieving, based on the discovery commands, the information from the one or more additional devices;
identifying, based on the information, a second device to which the device or port may connect to generate a path to an endpoint of the telecommunications network;
identifying, based on the device or port, the second device, and at least one additional device, a path from the location of the user to the endpoint in the telecommunications network;
generating an estimated time to provision the service using the path; and
presenting, at the first time, the estimated time to provision the service using the path.

2. The method of claim 1, further comprising:
receiving an acceptance of the estimated time from the user; and
provisioning the service for the user based on the path.

3. The method of claim 1, further comprising:
generating a prompt instructing a machine learning model to generate the estimated time based on the device or port and the second device;
inputting the prompt to the machine learning model; and
generating, using the machine learning model, the estimated time based on the prompt and training data indicative of estimated times to provision services based on resources of the telecommunications network and probabilities that users will accept the estimated times.

4. The method of claim 1, wherein generating the path occurs without information in inventory for the telecommunications network indicating which devices and ports are used for respective users and services.

5. The method of claim 1, wherein generating the path occurs with information in inventory for the telecommunications network indicating which devices and ports are used for respective users and services.

6. The method of claim 1, further comprising:
identifying at least one of a virtual local area network, a subinterface, or a route target based on the information,
wherein the path uses the at least one of the virtual local area network, the subinterface, or the route target.

7. The method of claim 1, further comprising:
identifying a first command protocol used by the second device; and
identifying a second command protocol used by a third device of the telecommunications network, and
wherein the discovery commands comprise a first command using the first command protocol and a second command using a second command protocol.

8. The method of claim 1, further comprising:
sending an indication to the user that the service has been provisioned for the user.

9. A system comprising:
memory coupled to at least one processor, the at least one processor configured to:
receive, at a first time, a user request for a service facilitated by a telecommunications network, the user request identifying a location of a user;
identify, based on the service, a device or port to which the user connects to access the telecommunications network;
send, based on the device or port, discovery commands to retrieve information from one or more additional devices in the telecommunications network;
retrieve, based on the discovery commands, the information from the one or more additional devices;
identify, based on the information, a second device to which the device or port may connect to generate a path to an endpoint of the telecommunications network;
identify, based on the device or port, the second device, and at least one additional device, a path from the location of the user to the endpoint in the telecommunications network;
generate an estimated time to provision the service using the path; and
present, at the first time, the estimated time to provision the service using the path.

10. The system of claim 9, wherein the at least one processor is further configured to:
receive an acceptance of the estimated time from the user; and
provision the service for the user based on the path.

11. The system of claim 9, wherein the at least one processor is further configured to:
generating a prompt instructing a machine learning model to generate the estimated time based on the device or port and the second device;
inputting the prompt to the machine learning model; and
generating, using the machine learning model, the estimated time based on the prompt and training data indicative of estimated times to provision services based on resources of the telecommunications network and probabilities that users will accept the estimated times.

12. The system of claim 9, wherein to generate the path occurs without information in inventory for the telecommunications network indicating which devices and ports are used for respective users and services.

13. The system of claim 9, wherein to generate the path occurs with information in inventory for the telecommunications network indicating which devices and ports are used for respective users and services.

14. The system of claim 9, wherein the at least one processor is further configured to:
identify at least one of a virtual local area network, a subinterface, or a route target based on the information,
wherein the path uses the at least one of the virtual local area network, the subinterface, or the route target.

15. The system of claim 9, wherein the at least one processor is further configured to:
identify a first command protocol used by the second device; and
identify a second command protocol used by a third device of the telecommunications network, and
wherein the discovery commands comprise a first command using the first command protocol and a second command using a second command protocol.

16. The system of claim 9, wherein the at least one processor is further configured to:
send an indication to the user that the service has been provisioned for the user.

17. A non-transitory computer-readable storage medium tangibly encoded with computer-executable instructions, that when executed, cause at least one processor to:
receive, at a first time, a user request for a service facilitated by a telecommunications network, the user request identifying a location of a user;
identify, based on the service, a device or port to which the user connects to access the telecommunications network;
send, based on the device or port, discovery commands to retrieve information from one or more additional devices in the telecommunications network;
retrieve, based on the discovery commands, the information from the one or more additional devices;
identify, based on the information, a second device to which the device or port may connect to generate a path to an endpoint of the telecommunications network;
identify, based on the device or port, the second device, and at least one additional device, a path from the location of the user to the endpoint in the telecommunications network;
generate an estimated time to provision the service using the path; and
present, at the first time, the estimated time to provision the service using the path.

18. The non-transitory computer-readable storage medium of claim 17, wherein execution of the instructions further causes the at least one processor to:
receive an acceptance of the estimated time from the user; and
provision the service for the user based on the path.

19. The non-transitory computer-readable storage medium of claim 18, wherein execution of the instructions further causes the at least one processor to:
generating a prompt instructing a machine learning model to generate the estimated time based on the device or port and the second device;
inputting the prompt to the machine learning model; and
generating, using the machine learning model, the estimated time based on the prompt and training data indicative of estimated times to provision services based on resources of the telecommunications network and probabilities that users will accept the estimated times.

20. The non-transitory computer-readable storage medium of claim 18, wherein execution of the instructions further causes the at least one processor to:
identify at least one of a virtual local area network, a subinterface, or a route target based on the information,
wherein the path uses the at least one of the virtual local area network, the subinterface, or the route target.
